(19) United States
(12) Patent Application Publication
(10) Pub. No.: US 2014/0111380 A1
(43) Pub. Date: Apr. 24, 2014

(54) METHOD FOR SHORT-RANGE PROXIMITY DERIVATION AND TRACKING

(71) Applicant: CAMBRIDGE SILICON RADIO LIMITED, Cambridge (GB)

(72) Inventors: Simon Gibbs, Bury St. Edmuunds (GB); Nicolas Graube, Barrington (GB); Ben Tarlow, Cottenham (GB); Murray Jarvis, Stapleford (GB); Athellina Rosina Ahmad Athsani, Santa Clara, CA (US); Saranjit Singh Saund, Los Altos, CA (US)

(73) Assignee: Cambridge Silicon Radio Limited, Cambridge (GB)

(21) Appl. No.: 13/763,899

(22) Filed: Feb. 11, 2013

Related U.S. Application Data
(60) Provisional application No. 61/717,066, filed on Oct. 22, 2012.
(60) Provisional application No. 61/725,094, filed on Nov. 12, 2012.
(60) Provisional application No. 61/717,246, filed on Oct. 23, 2012.

(51) Int. Cl. G01S 5/02

(52) U.S. Cl. CPC G01S 5/02
USPC 342/451

(57) ABSTRACT

A system has short-range transmission devices, each of which corresponds to a range of zones in a three dimensional space. The short-range devices are positioned at various locations within the three dimensional space and periodically broadcast signals. The zones are determined according to a plurality of signal characteristics sensed by client devices proximate to the short-range beacon transmission devices. In addition, the zones are assigned definitions.

### CROSS REFERENCE TO RELATED APPLICATIONS

This application claims priority to U.S. Provisional Application No. 61/717,066, filed Oct. 22, 2012, entitled ZONE OPTIMIZATION SYSTEM, U.S. Provisional Application No. 61/725,094, filed Nov. 12, 2012, entitled 3D ZONE DETERMINATION and U.S. Provisional Application No. 61/717,246, filed Oct. 23, 2012, entitled A METHOD FOR SHORT-RANGE PROXIMITY DERIVATION AND TRACKING, the contents of which are incorporated herein by reference.

### FIELD OF THE INVENTION

The present invention is directed toward proximity awareness in three dimensional space and, in particular to systems and methods associated with determining proximity awareness in three dimensional space in terms of a range of zones based on interactions among a communications device and a plurality of short-range transmission devices.

### BACKGROUND OF THE INVENTION

Short-range beacons using technologies such as infrared, ultrasonics, near-field communications (NFC) and Bluetooth® have been used to determine the presence of a device in the transmission range of the beacon. These technologies, may, for example, determine whether one Bluetooth enabled device is separated from another Bluetooth enabled device in order to sound an alarm.

### SUMMARY OF THE INVENTION

An example embodiment of the present invention includes a system having one or more short-range transmission devices, each of which corresponds to a set of zones in a three dimensional space. The short-range devices are positioned at various locations within the three dimensional space. The zones are then determined according to a one or more signal characteristics of the signals broadcast by short-range device(s) as sensed by a client device or devices proximate to the short-range transmission device(s). In addition, the zones are assigned definitions.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bi-directional exchange between these components. According to common practice, the various features of the drawings are not drawn to the scale. Also, the dimensions of the various features are arbitrarily expanded or reduced for clarity. Included in the drawings are the following figures:

FIG. 1A is a top-view diagram illustrating an embodiment of a system for determining zones in an indoor environment.

FIG. 1B is a top-view diagram of an embodiment showing the determination of a plurality of zones by a RF transmitter.

FIG. 1C is a top-view diagram of another embodiment depicting the determination of a zone by a plurality of RF transmitters.

FIG. 1D is a top-view diagram of another embodiment illustrating the determination of a plurality of zones by a plurality of RF transmitters.

FIG. 1E is a top-view diagram of another embodiment showing the determination of a zone by a plurality of RF transmitters and zones.

FIG. 2A is a block diagram showing one embodiment of a client device.

FIG. 2B is a block diagram depicting one embodiment of a server.

FIG. 2C is a block diagram illustrating one embodiment of a transponder.

FIG. 3 is a flow-chart of an embodiment describing a method of a client device determining zone information according to signal characteristics.

FIG. 4 is a flow-chart of another embodiment depicting a method of a server determining zone information according to signal characteristics.

FIG. 5 is a block diagram describing various communication modes of the client device, transponder and the server.

FIG. 6 is a flow-chart of another embodiment describing a method for estimating zones.

### DETAILED DESCRIPTION OF THE INVENTION

With the proliferation of connected mobile devices and sensors, it may be possible for users, employing mobile client devices, to gather information concerning a proximity aware indoor area and, based on this information, interact with transponders covering the area to trigger actions based on the proximity of the client device to one or more of the transponders. To date, indoor proximity awareness is limited to, for example, store front door or check-out stands. Current navigation and positioning systems are optimized for outdoor environments and do not function well inside buildings. Location determination for an interior space may require dense and expensive infrastructures, for example, WiFi Access Points and/or video cameras. In order to establish proximity aware systems may further need manual intervention by the client, such as, “check-ins”, in order to communicate with the system. Thus, indoor proximity awareness continues to be a challenge.

Embodiments of the invention overcome the limitations by establishing proximity aware zones in a three dimensional space associated with short-range transmission devices such as RF transponders and mobile communication devices and by associating these zones with definitions according to which actions may be taken by clients in possession of the mobile devices.

The subject invention is described in terms of short-range transmitters (e.g. Bluetooth® transmitters) the signals from which are captured by mobile client devices, such as a mobile telephone including a Bluetooth transceiver. It is contemplated, however, that other types of transmitter and receivers can be used, for example infrared, ultrasonic, NFC. In addition, as described below, it is contemplated that the transponders may be RF transceivers that do not broadcast signals but, instead, sense signals broadcast by the portable mobile devices. Furthermore, although the transponders are described as being stationary, it is contemplated that they may be mobile devices as well and, thus, that the zones defined for these transponders may move throughout the space. Furthermore, although the invention is described in terms of a retail environment, it is contemplated that it has broader application including, without limitation, security, enterprise workflow, gaming and social interactions. In short, it is useful in any environment in which different actions may be triggered based on different levels of proximity among devices.

An example proximity system according to the subject invention employs a plurality of transponders each of which may broadcast a signal that is sensed by the client device or sense a signal that is broadcast by a client device. Each transponder may be associated with a region of interest. A region of interest may be a particular region of an area covered by the transponders, for example, a portion of a shelving unit in a retail store. The transponder associated with the region of interest may be used to define one or more zones. Zones are defined relative to one or more of the transponders, as described below. Signaling between the client device and the transponder(s) may establish at least a probability of the client device being in a particular zone relative to the transponder. Each of the zones may be considered to be a range of locations relative to each transponder indicating, for example, respectively different levels of proximity between the client device and the region of interest in the covered area.

The collection of RF transponders (e.g. short-range transmitters) taken as a whole or individually, in combination with their broadcast signals captured by a client device, and signal characteristics that are derived from the broadcast signals, help to determine zones in the indoor area. The signal characteristics attributed to an RF transponder can be, but are not limited to, a range of its signal strengths, a range of the times of arrival of a distinguishable sequence, a range of signal qualities, a range of round trip times of an emitted signal and/or a range of phases of the signal. The zones corresponding to using these characteristics may be associated subsequently with definitions. For example, in a retail environment, a zone may be determined probabilistically according to a measured signal strength of a transponder located in an aisle of a retail store. This zone, in turn, may be defined in terms of an estimated proximity of the client device to goods being sold in that aisle or in a portion of the aisle covered by the transponder.

Moreover, different zones and their corresponding definitions may be delimited according to a variations in either a number of RF transponders or on different sensed signal characteristics. For example, in a proximity aware system, a plurality of transponders may each broadcast a signal that is sensed by a client device or they may sense a signal broadcast by the client device. Each transponder may also be associated with one or more zones where each zone indicates for example, different levels of proximity between the client device and one or more regions of interest associated with the transponder.

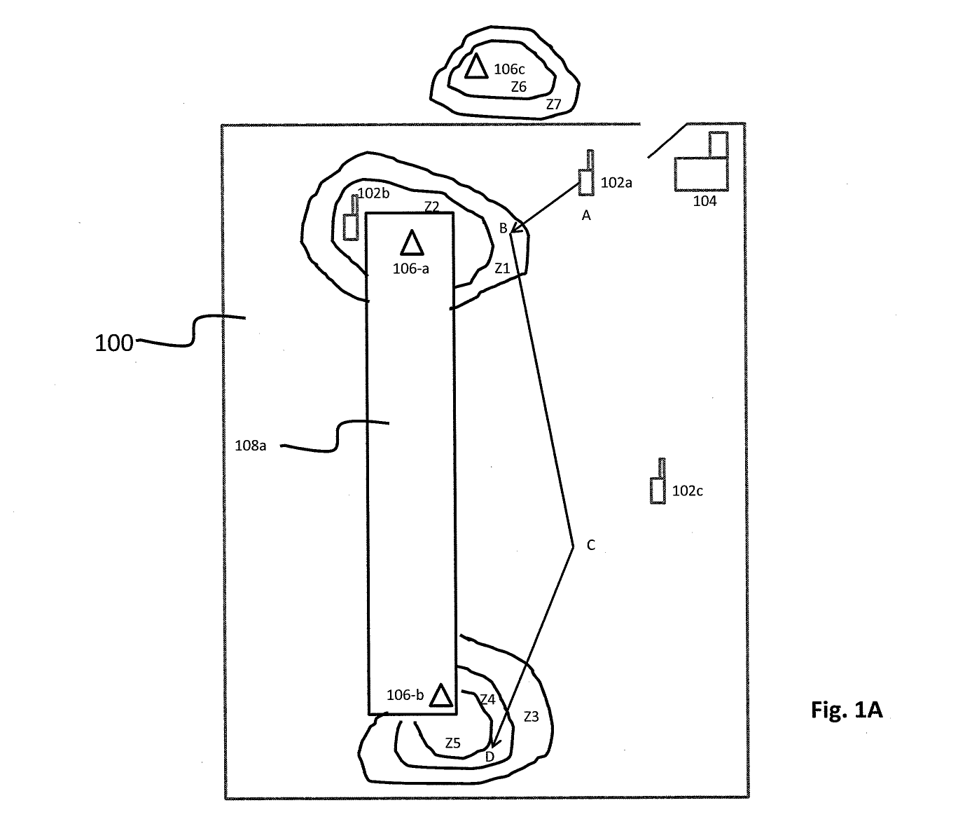

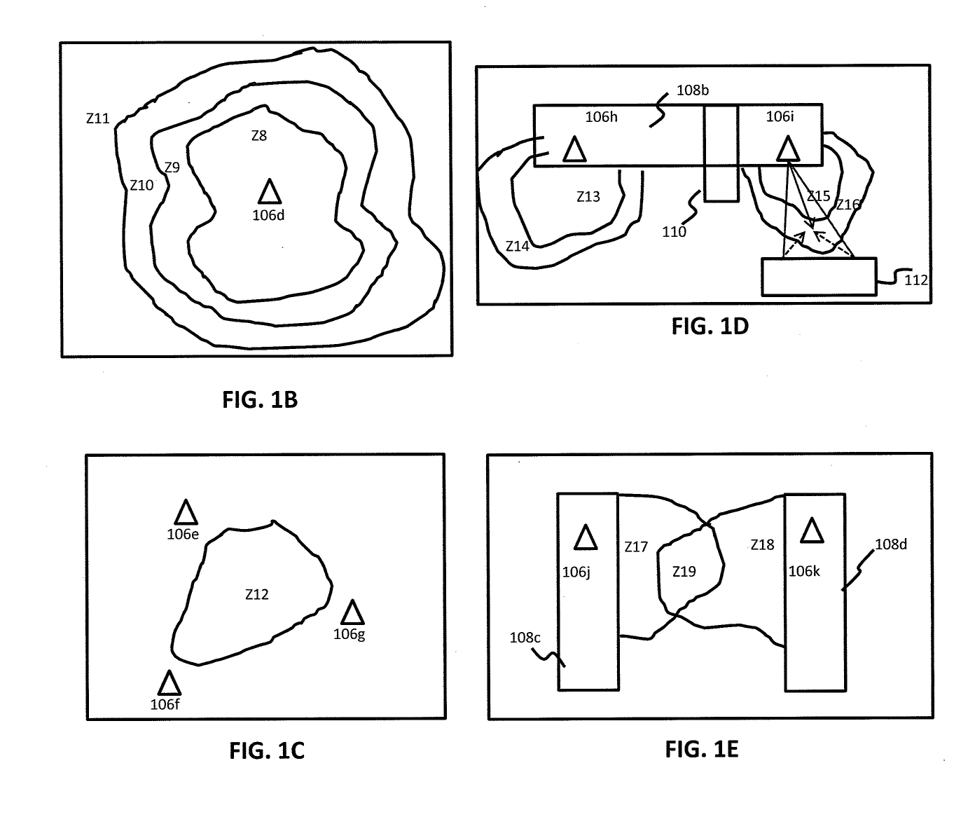

The system may associate one or more actions with each of the zones of each of the transponders and these actions may be invoked by the client device if specific conditions are met. FIG. 1A is a top-view drawing of a portion of a self-serve retail venue 100, such as a grocery store, including a shelf unit 108a. Transponders 106a and 106b are coupled to the shelf unit 108a such that their broadcast signals may be sensed by client devices 102a and 102b, for example. Transponder 106c is located outside the retail venue and broadcasts signals that may be sensed by a client device when it moves outside, for example. Also, client device 102c is in an area of the retail venue 100 where it may be outside the range of the transponders 106. Device 102c may, however, communicate with the other client devices 102a and 102b, for example via a direct point-to-point communication in order to exchange information such as zone definitions to reduce the communication burden on the server 104.

In a server-centric example, the client device 102a, after entering the retail venue 100, transmits information about the sensed transponder signal characteristics 106a to the server 104 which may use the information to determine the zone of the client device. For example, client device 102a after moving to point B from point A, and communicating the signal characteristics of the transponder 106a to the sever 104, may receive information about zone Z1, for example. The client device 102a may also communicate with client device 102b in order to receive information about zone Z2 and send information about zone Z1, for example. This operation may repeat as the client device moves from zone to zone. A similar exchange between device 102a and the server 104 may occur when the client device 102a moves to point D in zone Z4, for example.

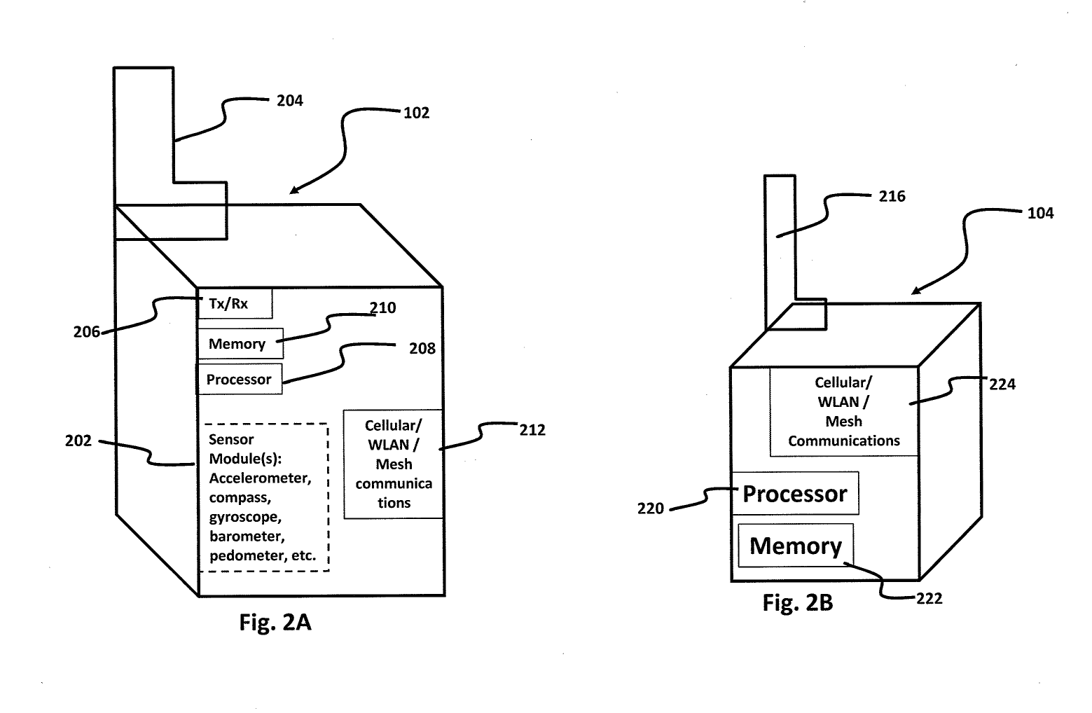

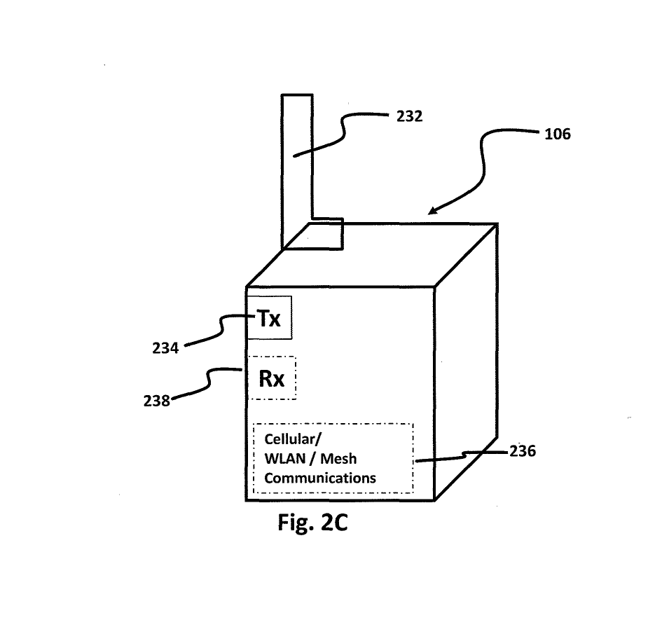

In one embodiment of the invention, the transponders 106 may be receiving devices that sense signals broadcast by the client devices 102 and send identifying information about the client device and, optionally, sensed signal strength measurements to the server 104 so that the server 104 may estimate the zone occupied by the client device 102 relative to the transponder from which it received the client's information. The broadcast signals may be radio frequency (RF) or ultrasonic signals or they may be light signals having wavelengths within the infrared (IR), visible or ultra-violet (UV) ranges. Example client, server and transponder devices are described below with reference to FIGS. 2A, 2B and 2C.

Server-centric systems reduce the computational load on the client device but may greatly increase the communications load in the covered area and, thus, the latency of the zone determination. It is contemplated that the determination of the zones may be performed by the client device instead of by the server. In this embodiment, the client device may send only the transponder ID to the server. The server may respond with definitions for zones associated with the transponder and with other nearby transponders. These zones may be defined based on proximity to the transponder. The client device may then analyze the sensed transponder signal according to these zone definitions to determine its distance from the transponder, and, thus, the zone it occupies. In one embodiment, the server may send information on all zones in the covered area to the client device which may then store this data in an internal memory. This information may, for example, be conveyed when the client device encounters a first transponder, when the client device enters the covered area or even before the client device enters the area, responsive to a registration process.

FIGS. 1B-E illustrates a variety of ways to define zones. For example, as shown in FIG. 1B, the defined zones Z8-Z11 may be associated with the transponder 106d, for example. Each zone defines a range of proximity or distances between the client device (not shown) and the transponder 106d. The example zones range from Z8, which is the closest to the transponder 106d, to zone Z11 which is farthest away. The example zones may be defined, for example, by respective probability distributions of signal strength. Thus, a client device measuring a signal strength close to the mean signal strength of a specific zone will likely be a member of that zone. Furthermore, each zone may be associated with a definition based in part on distance between the zone and the region of interest associated with the transponder, as described above. The above mentioned determination of zones may be carried out by the client device or by the server, for example, upon receiving signal characteristics data from the client device. In a probabilistic model, signal strength values between zones may be assigned to one zone or the other based on their respective probabilities of being in the zone.

In another example, a zone may be defined based on signals provided by a number of transponders as communicated to a client device and/or a server. For example, as shown in FIG. 1C, zone Z12 is defined by taking the signal characteristics of the transponders 106e, 106f and 106g conjointly. For example, zone Z12 may be defined by distributions of time differences of arrival of respective signals from the transponders 106e, 106f and 106g. Alternatively, zone Z12 may be defined by a distribution of signal strengths from the three transponders.

In yet another example, a physical element may influence the definition of a zone. As shown in FIG. 1D, transponders 106h and 106i are placed at opposite ends of a center divider 110 of a grounded metal shelving unit 110. As such, distinct zones Z13-Z14 corresponding to a range of signal characteristics of transponder 106h and another set of distinct zones Z15-Z16 corresponding to a range of signal characteristics of transponder 106i, are defined based on the signal attenuation caused by the center divider 110. Moreover, the center divider 110 may distort the shapes of the zones, by either reflecting the signals or by absorbing the signals broadcast by the transponders.

In another example, a client device (not shown) located in zone Z16, may sense reflected signals (shown in dashed arrows), reflected by metal divider 112 in addition to the original direct line-of-sight signal (shown in solid arrow) from the transponder 106i. The reflected signals may appear to arrive from longer distances with different signal strengths compared to the original signal sensed by the client device. Thus, in one instance due to constructive interference of the signals, the combined strength of the signal may be stronger (or weaker due to destructive interference of the signals) than the original signal strength. These signal strength variations may be incorporated into the probability distributions that define the zones. Hence, determination of zones may also account for the multipath propagation of signals, due to physical obstacles/elements, causing attenuation and amplification of signals, for example. Furthermore, the client device may be further configured to filter out spurious signals, for example, as described below.

In another example, a zone may be defined based on a combination of two different zones. For example, as shown in FIG. 1E, a client device (not shown) may be located where zones Z18 and Z17 overlap. In this instance, zone Z19 is not determined by the relative signal strengths of signals from transponders 106j and 106k but from the intersection of zones Z17 and Z18 defined for the respective transponders. Zone Z17 is defined distinctly by the transponder 106j and zone Z18 is distinctly defined by the transponder 106k. Thus, the client device being at the overlapping location collects signals characteristics of both the transponders 106j and 106k and determines its location as being in the zones Z17 and Z18. Thus, zone Z19 may be defined where the client device is located in both of these zones. It is contemplated that other combinations of zones may be used to define other zones. These include, for example, a union, an intersection, or the complement of the intersection of two or more distinct zones.

In an exemplary embodiment of the invention, the zones may be defined during an initialization step in which an administrator, for example, a store employee, obtains a set of signal characteristic readings for each transponder or group of transponders at various distances from the transponder(s) to define the zones. Information describing these zones may be stored on the server and provided to the client devices 102 either in response to a query from a client device or as an initial download of zone information to a memory in the client device 102. For example, as shown in FIG. 1, the administrator may define zones for the transponders 106a-c. The administrator may further assign definitions to the corresponding zones. For example, the administrator may assign a definition, “beverage section”, to the zone Z2 corresponding to the transponder 106a, whereas the zone Z5 corresponding to the transponder 106b may have an assignment of “produce section”, for example. The administrator may further assign definitions of “welcome area” to the zones corresponding to the transponder 106c, located outside the store.

Alternatively, zones may be defined using crowd-sourced signal harvesting. Using this technique, the administrator may attach the transponders to the shelves and allow the zones to be defined automatically by user interaction. For example, a user with a client device may traverse the store and purchase items. When the user checks out, a server may receive the set of signal strengths and transponder IDs encountered by the user as well as a set of purchased products. Based on similar data from many customers, the server may correlate a particular signal strength for a particular transponder with the purchase of a product. The server may then define this signal strength as a zone associated with a region of interest including this product. This zone definition may result in zone definitions for other, adjacent zones. As an alternative to having the server determine the zones in this manner, the client device may determine the zones over time through repeated interactions with the transponders in the covered area.

The client device may determine its zone membership based on a sensed signal characteristic. For example, the server may generate frequency distributions of the RSSI corresponding to the transponders and may send information on all zones or on a subset of zones to a client device along with definitions of the zones based on relative proximity to the transponders. The client device may then analyze the RSSI and decode the transponder label of the sensed transponder signal to determine which zone it is in.

Proximity between the transponder and the client device may be determined based on the strength of the signal broadcast by the transponder and sensed signal strength. If there are no obstructions between the transponder and the client device, the sensed signal strength is proportional to S/x², where S is the broadcast signal strength and x is the distance between the transponder and the client device. The broadcast signal strength may be known to the client device, may be received by the client device from the server or may be sent by the transponder as part of the message broadcast by the transponder.

It may also be desirable to calibrate a client device to a reference transponder. The reference transponder may be present at a kiosk of the store and a user may calibrate the client device, specifically a transponder device located in the kiosk may broadcast a reference signal while registering the client device and is at a known location relative to the transponder. The signal characteristic values thus processed by the client device afterwards may be used to normalize sensed transponder signal characteristics. Calibration could also occur during a normal course of a client device within the store. In such an example, calibration may be based on data from MEMS sensor, for example, stopping while proximate to transponders 106a or 106b may indicate the client device is respectively in zone Z2 or Z5, for example, while moving quickly past the transponder 106b, as shown in FIG. 1, may indicate zone Z3 or Z4. The known strengths of the transponders in these zones may be used to calibrate the client device.

Optionally, the client device may, for example, download a zone map from the server and the client device may then process the sensed transponder signals to determine the zone and assign definition to the zone based on the zone map, transponder identifiers and signal characteristics. For example, the zone map may define zones in terms of proximity ranges from each of the transponders. The client device may then calculate its proximity to the transponder based on knowledge of the broadcast and sensed signal strengths. In another example, the zone map may contain data defining signal strength probability distributions for each zone and the client device may calculate it's probability of being in that zone based on the sensed signal strength. In yet another example, the zone map may include a transition matrix and the client device may determine its current zone based on a history of zones it has visited in the past. The zone map generated by the server may also conform to a known layout of the covered area in which the physical locations of the transponders are known.

Alternatively, in defining the zones, the server 104 or client device 102, in addition to the signal characteristics of the transponders, may take into account of other factors which may influence the propagation of signals to or from the transponders 104, such as, without limitation, the density of the atmosphere, the material, texture or constitution of objects proximate to the transponders such as the shelf unit 108. These factors define the zone context which is used by the server to further refine the zones for the client device 102. Furthermore, the client or server may also take into account context concerning each transponder 106. Factors defining the transponder context include, without limitation, battery power and the condition and location of the transponder. When the client device 102 makes the zone determination, these values may be obtained from the transponder directly or from the server in response to the client device sending the transponder ID to the server.

The system may also take into account context information related to the client device such as, without limitation, its orientation, speed of movement and altitude. In one exemplary embodiment, the context of the client device may be determined using sensors such as, for example, an accelerometer, a pedometer, a compass and an altimeter. It is contemplated that these sensors may be micro-electromechanical sensor (MEMS) devices integral with the client device 102.

FIG. 2A is a block diagram of an example client device 102. The client device, which may, for example, be a conventional smart phone, includes a receiver and/or transmitter 206, a cellular/WLAN/mesh communications module 212, a memory 210, a sensor module 202, a processor 208 and one or more antennas 204. The receiver 206 senses the low-power signals broadcast by the transponders 106 via one of the antennas 204. The processor 208 may process the signals sensed by the receiver in order to determine the characteristics of the signals and further store these characteristics into the memory 210. For example, the signal characteristics may be further processed by the processor 208 to determine the zone of the client device 102. The signal characteristics may be sent to the server 104 via the cellular/WLAN/mesh communications module 212. The module 212, which may include, for example, a IEEE 802.14 Zigbee® transceiver or a Bluetooth transceiver, may communicate with other client devices 102, for example, to share zone information obtained from the server 104. Communication between client devices may be implemented using the short-range communication module 212, for example using a mesh network, or alternatively, using the short-range communications module 206.

The example client device 102 further includes an optional sensor module 202 that may include one or more of an accelerometer, a gyroscope, a compass, a pedometer and/or a barometer. As described above the sensor module may be used to gather information on movement of the client device. This information may be processed locally by the processor 208 or it may be sent to the server 104 in addition to signal characteristics for determining zone information and a definition of the zone. In one example, the sensor module of the client device may also include a camera (not shown) or bar-code scanner (not shown) that a user may employ to scan barcodes or QR codes of the products on shelves 108, for example in response to a prompt from the client device, to assist in generating a definition of the zone.

FIG. 2B is a block diagram of an exemplary embodiment of server 104. The example server includes a processor 220, memory 222, a cellular/WLAN/mesh communication module 224 and antennas 216. The example server 104 is configured to communicate with the client devices using the cellular/WLAN/mesh communication module 224. For example, the server 104 may receive transponder IDs and/or transponder signal characteristics using the cellular/WLAN/mesh communication module 224 and the processor 220 may process the data to determine zone information and corresponding definition of the zones which may be stored in the memory 222. The cellular/WLAN/mesh communication module 224 may also send the stored data to a requesting client device 102. As described above, the server may be configured to communicate with the transponders 106 via the WLAN communication module 224, for example, which may use one or more antennas 216 to communicate with the client devices 102 and/or the transponder devices 106.

FIG. 2C is a block diagram of a transponder device 106 suitable for use with the subject invention. The device includes a transmitter 234, an antenna 232, an optional receiver 238 and an optional cellular WLAN/mesh communication module 236. The antenna may be used for both the transmitter 234 and WLAN/mesh communications module 236 or separate antennas may be used. In one exemplary embodiment, the transmitter 234 is a Bluetooth low energy (BLE) transmitter. This device sends signals to client devices that are in the proximity of the transponder 106.

In one example, the transponder 106 includes only the transmitter 234 and antenna 232. Although not shown, the transponder also includes a power source, for example, a lithium battery. Because it periodically broadcasts a low-power signal, the example transponder 106 may operate for several years using the battery.

In an another example, the transponder 106 may include the antenna 232, and receiver 238 and may be configured to sense low-power signals (e.g. BLE) signals broadcast by the client devices and to send its identity and information on the detected client devices to the server, for example, via cellular/WLAN/mesh communications unit 236. Because this device may transmit higher powered signals more often than the transmit-only transponder, it may include a larger battery or may be connected to the store's electrical network.

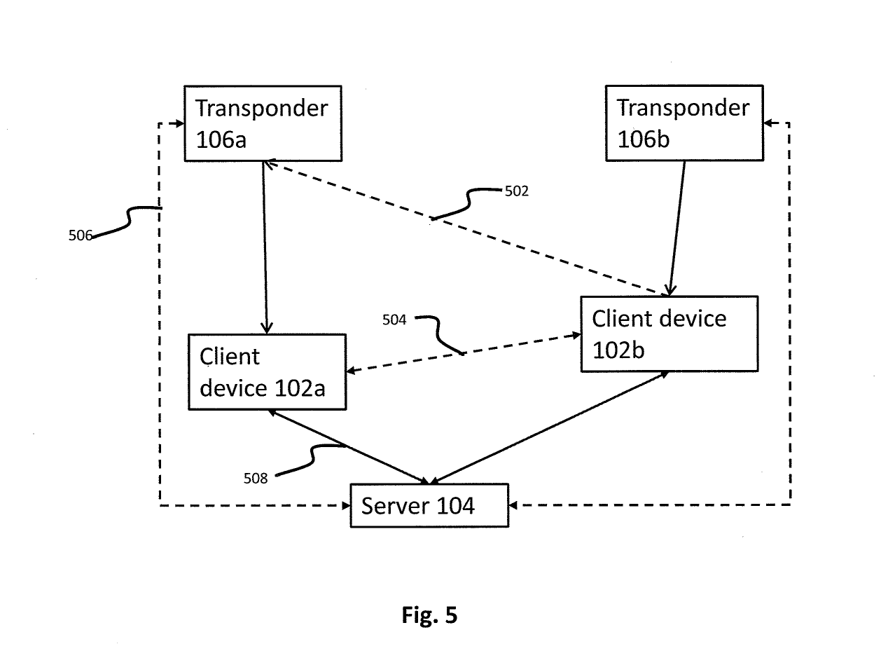

FIG. 5 is a block diagram which is useful for describing the various communications modes of the client devices 102, transponders 106 and server 104. In FIG. 5, the solid lines and dashed lines indicate communications among the devices for different embodiments.

In one embodiment, the transponders 106 are transmit-only devices that emit signals having signal characteristics and including a transponder label asynchronously and at regular intervals. These signals are sensed by one or more client devices proximate to one of the transponders. Each client device 102 senses signals from the transponders that are within range and can collect, none, one or more signal characteristics over a period of time. In addition, the client device may receive the transponder signal and decode the transponder label from it. For example, with reference to FIG. 2A, the client device 102 senses the low-power signals broadcast by the transponders 106 via one of the antennas 204. Information about the sensed signals, such as RSSI, RTT, time of arrival, quality of signal and signal phase are digitized, for example, by an internal ADC (not shown) and stored into the memory 210. In addition, the transponder label is decoded from the received signal. In an exemplary embodiment of the invention, the digital values may be analyzed by the processor 208 (i.e. compared to zone definitions received from the server 104) to determine the current zone location of the client device.

In another embodiment, as shown by the dashed line 502, the transponders 104 may be configured to sense low-power signals (e.g. BLE) signals broadcast by the client devices and to send their identities and information on the detected client devices to the server, for example as shown by dashed line 506. The information sent may include a client device identifier and characteristics of the sensed signal. The server may then determine the zone corresponding to the transponder ID and client device signal characteristics and also the definitions of the zones. The server may then send the zone information to the identified client device, for example as shown by line 508.

Client device 102 may also be configured to have bi-directional communication with the server 104 and further transmit signal characteristics wherein determination of proximity of the client device with respect to the transponder or zones for a predetermined time may be performed by the server. During the communication, the client device may also receive definitions of the zones from the server 104, for example. Alternatively, the client device 102 may provide such information to the server.

As indicated by dashed line 504, a cross client communication may take place, for example. In such a scenario, the client devices 102 may communicate information among each other regarding their respective zones and definitions of the zones, for example.

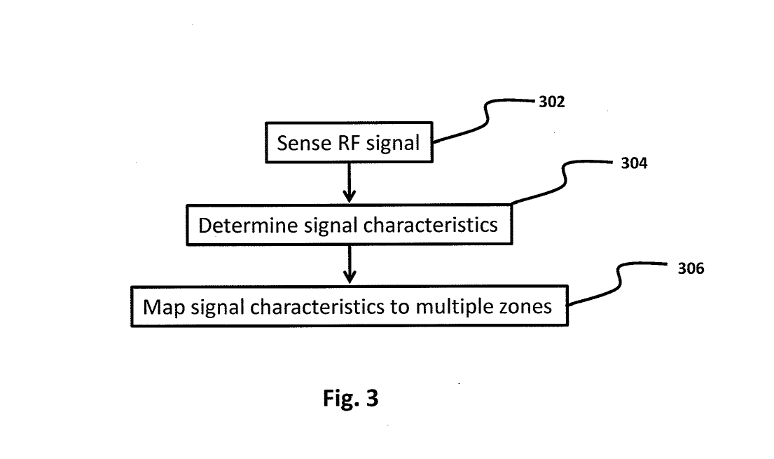

In one embodiment, the zones may be defined manually. For example, as shown in FIG. 3, at step 302, a client device located proximate to a transponder, senses the transponder signal. The client device may be configured, as described above, to extract signal characteristics from the sensed signal (step 304). These signal characteristics may then be mapped to multiple zones (step 306), as described above.

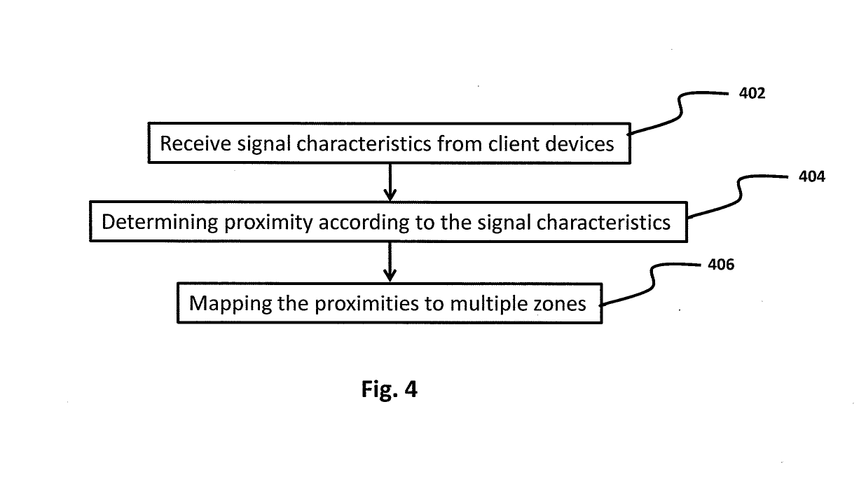

In yet another embodiment, the server 104 may be configured to determine the zones as described in the flow diagram of FIG. 4. At step 402, of this example, the server 104 is configured to receive sensed signal characteristics from at least one of the client devices. The signal characteristics may be derived from the signals broadcast by the transponders and sensed by the client devices. At step 404, the server then processes the signal characteristics in order to determine a proximities corresponding to a distribution of the signal characteristics. Following this, the server may map the proximities to multiple zones (step 406). The server may be further configured, to assign definitions to these zones. The server may be further configured to send the zones and the definitions of the zones to a requesting client device, for example.

In an another embodiment, the zone estimation may be performed automatically without the intervention of a store administrator setting up the zones or the and without the client device requiring a downloaded map of the store. A brief overview of the process is given below followed by a detailed description.

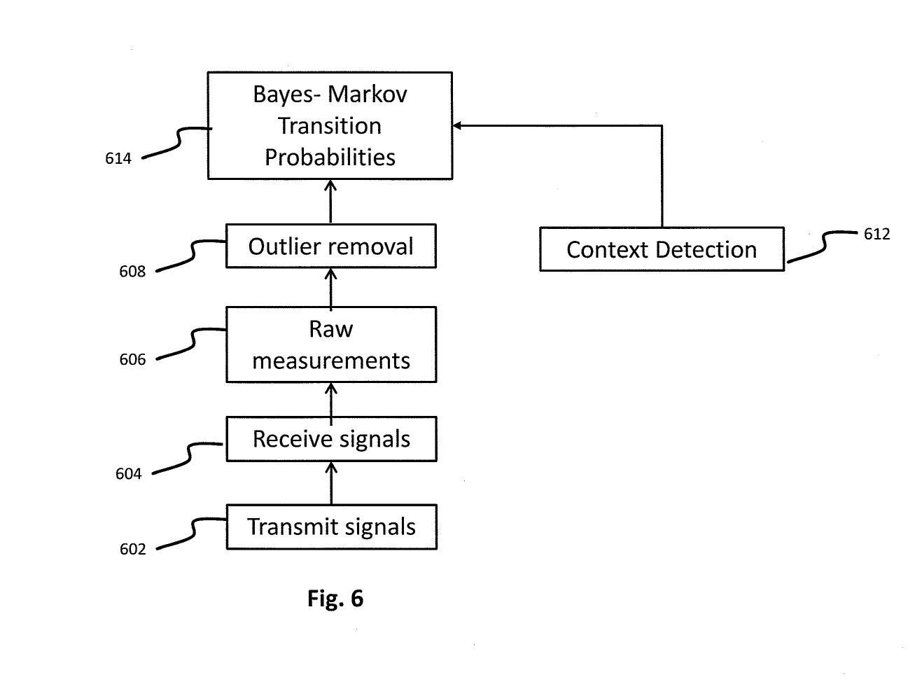

As shown in FIG. 6, at step 602 of this example, transponders 106 broadcast BLE signals, These signals may be emitted asynchronously by the transponders and at regular intervals, for example. As described above, if the transponders use BLE advertisement messages, pairing of the client devices with the transponders is not necessary. The signals may be subject to multi-path, attenuation, amplification, due to indoor obstacles, environment, etc. (step 604).

As shown at step 606, the client device 102 may also be configured to decode associated payload data, for example forward error correction (FEC) code, embedded in the broadcast signals to obtain a measure of signal quality (e.g. number of errors). Alternatively, signal-to-noise ratio (SNR) may be used as a measure of signal quality. The client device 102 then estimates signal characteristics derived from the sensed transponder. The client device may also be configured to send the signal characteristics to the server for example. The client device may be further configured to remove outliers found in the distribution of the signal characteristics (step 608).

In one example embodiment, the filtering step 608 may analyze three successive samples representing sensed signal strength (e.g. RSSI). If the variation between the middle sample and both of the other two samples is greater than a predetermined threshold, then the sample is invalid and is discarded.

As described earlier, context information related to the client device such as, without limitation, its orientation, speed of movement and altitude may be determined using MEMS sensors of the client device (step 612). The client device may acquire or possess initial information on all zones along with definitions of the zones indicating relative proximity to the transponders according to the distribution of the signal characteristics. The client device may then combine that information with the context information to estimate which zone it is in, based on probabilities (step 614).

In detail, for each transponder 106, the client device may generate a set of values, for example, p(Z1), p(Z2), p(Z3) corresponding to the current estimates of the probabilities of the client device 102 being in each of these zones, namely Z1, Z2 and Z3. Alternatively, the sever may provide this information to the client device.

The client device 102 may generate, for example, filtered signal characteristics such as RSSI, corresponding to the transponder 106, for which the set of values gets updated. The largest probability value in the set may determine the zone that the client device 102 is in, for example.

Further the client device may be in motion and changing zones within the store. As such, the motion of the client device 102 can be modeled as a Markov chain. A Markov chain is a statistical model that models the state of a system with a random variable that changes through time. Thus, in this embodiment, the state in the Markov chain corresponds to the zone in which the client device 102 is present at a given time. The Markov chain typically uses a transition matrix that defines the probability of moving from any zone in the covered area to any other zone.

For example, for a given time step, the transition matrix of the Markov chain encapsulates estimates of the conditional probabilities that the client device 102 will move between every possible pair of zones (including no change in zone). Moreover, these transition probability values may be dependent on: (a) definition of the zones, (b) the duration between the updates, (c) estimate of the probability distribution for the speed of the motion of the client device.

An entry in the transition matrix, P_{T(Δt)}(i|j), for example, which represents probability of a transition of the client device from the jth zone to the ith zone occurring at the end of an epoch of duration Δt, can be defined by the following equation,

$${P}_{T ( Δ t )} ( i \vert j ) = {\int }_{{D}_{j}} {f}_{j} ( r ) {\int }_{0 +}^{∞} g ( s ) \frac{{ℒ}_{2} ( {D}_{i} ⋂ {D}_{s Δ t} ( r ) )}{{π ( s Δ t )}^{2}} d s {d}^{2} r \qquad ( 1 )$$

in which the outer integral is over the domain Dⱼ of zone j, fⱼ(r) is the probability density function for location within zone j conditional on presence within zone j, g(s) is the probability density function for user speed. In one example, the speed distribution may be gathered by use of context information such as walking/stationary inferred from sensors such as accelerometers, gyros, for example. [symbol] ₂(Dᵢ∩D_{sΔt(r)}) is the area of the intersection of the domain of zone i with a disc radius sΔt centered on the location r in zone j.

The current state, or the zone in which the client device 102 is present, may not be directly observable, for example. As such, its estimation may be achieved through Bayesian inference from incoming signal strength in which a-priori data is provided through the modeling, as described above.

As such, the posterior probability, P(Zᵢ|x) can be calculated as:

P(Zᵢ|x)=p(x|Zᵢ)P(Zᵢ)/p(x) (2)

where, P(Zᵢ|x) is the posterior probability associated with the hypothesis of the client device 102 being present in the ith zone, p(x|Zᵢ) is the likelihood of a measurement yielding result x conditional on the hypothesis of presence in the ith zone,
and P(Zᵢ) is the prior probability associated with the hypothesis of zone i and calculated as

P(Zᵢ)=P_{T(Δt)}(i|j)P₀(Zᵢ) (3)

where P₀(Zⱼ) is the probability at the beginning of an epoch, and P_{T(Δt)}(i|j), as calculated in Equation (1), represents probability of a transition of the client device from the jth zone to the ith zone occurring at the end of an epoch of duration Δt as described above. Also, p(x) is the probability density associated with a measurement of value x and calculated as:

p(x)=p(x|Zⱼ)P(Zⱼ) (4)

With summation over repeated indices implied.
The reception of a subsequent measurement is handled by updating the initial probability P₀ with the current posterior and the use of the transition matrix defined for temporal separation of the last two measurements. Based on the calculations, the zone having the highest probability is the zone occupied by the client device.

The transition matrix may be a static matrix generated based on training data and stored on the server. Alternatively, it may be updated based on data collected by the system. For example, the purchase of a particular item may indicate that the client device was in zone X. If the probability calculation when the client device was proximate to zone X does not indicate that the client entered zone X then the conditional probabilities between zones preceding zone X, in the path traveled by the user, may be adjusted to increase the likelihood of transitions between these zones and zone X.

In another embodiment, the server 104, may refine the location of a client device 102 during the process of estimating the zones as described above. Particularly, the system may be configured to determine whether the client device is inside or outside a particular area, for example. This may be performed by checking the zone membership of a client device over time. The server 104 may detect a sequence in which the client device 102 is detecting a set of zones (outside or inside). An application of such an embodiment may be detection of a client device entering or leaving a particular room, for example. As shown in FIG. 1, in one example, the server 104 may receive signal characteristics corresponding to zones Z1, Z3 and Z4, in a sequence, for a predetermined time, from the client device 102a. Thus, the server 104, based on the sequence of the received signal characteristics determines that the client device is inside the store for that predetermined amount of time. Whereas, in another example, the server 104 may detect signal characteristics of zones Z1, Z7 and Z6, in another sequence, from the client device 102-a, for example. As a result, based on the sequence of the received signal characteristics, the server 104 may determined that the client device is going outside upon leaving the store, for example.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method for determining a plurality of zones in a predetermined area associated with a system including a server, a plurality of transponders and a plurality of client devices configured to communicate with the server, the method comprising at least one client device:
sensing at least one signal characteristic from at least one transponder of the plurality of transponders;
determining proximity between the client device and the at least one transponder based on the signal characteristics; and
mapping the determined proximity to at least one zone.

2. The method of claim 1, further includes a step of assigning a definition to the at least one zone.

3. The method of claim 1, wherein the step of sensing the at least one signal characteristic senses signal characteristics of a signal that is emitted asynchronously by the at least one transponder at regular intervals.

4. The method of claim 1, further including a step of calibrating the client device at least with respect to a reference transponder prior to sensing the at least one signal characteristic.

5. The method of claim 1, wherein the step of sensing the at least one signal characteristic further includes a step of determining at least one definition of a region of interest associated with the at least one transponder.

6. The method of claim 1, wherein the step of sensing the at least one signal characteristic includes sensing received signal strength of a signal broadcast by the at least one transponder.

7. The method of claim 6, wherein the step of determining proximity includes:
receiving a value indicating broadcast signal strength of the signal broadcast by the at least one transponder; and
comparing the sensed signal strength to broadcast signal strength.

8. A method for determining a plurality of zones in a predetermined area associated with a system including a server, a plurality of transponders and a plurality of client devices configured to communicate with the server, the method comprising the server:
receiving, from at least one of the client device, a plurality of sensed signal characteristics, derived from signals broadcast by the plurality of transponders;
determining respective proximities between the at least one client device and the plurality of transponders according to the sensed signal characteristics; and
mapping the proximity determinations to at least one zone.

9. The method of claim 8 wherein the at least one zone includes a plurality of zones and the method further includes a step of assigning a plurality of definitions to the respective plurality of zones.

10. The method of claim 9, further includes a step of sending information about the zones including the plurality of definitions of the zones to the at least one client device.

11. The method of claim 10, wherein the step of sending the information about the zones further includes sending information about ones of the plurality of zones corresponding to signals sensed by the at least one client device at a predetermined instant to the at least one client device.

12. The method of claim 8, wherein the step of receiving the plurality of sensed signal characteristics further includes receiving at least one of a range of signal strengths, a range of times of arrival of a distinguishable sequence of the signals, a range of round trip times of the signals, and a range of phases of the signals.

13. The method of claim 8, wherein the step of receiving the plurality of signal characteristics further includes receiving distinct signal characteristics each corresponding to a respective one of the plurality of transponders at a respective location.

14. The method of claim 8, wherein the step of receiving the plurality of signal characteristics further includes receiving at least one of the plurality of signal characteristics of a signal broadcast by at least one of the transponders located outside of the predetermined area.

15. The method of claim 8, wherein the step of mapping the proximity determinations to the at least one zone further includes a step of mapping the at least one zone to a layout of the predetermined area.

16. The method of claim 8, wherein the step of mapping the proximity determinations to the at least one zone further includes assigning corresponding definitions to the zones and the method further includes determining a plurality of distinct zones and assigning distinct definitions corresponding to the plurality of distinct zones based on multiple ones of the plurality of transponders at respectively different locations.

17. The method of claim 8, wherein the step of mapping the proximity determinations to the at least one zone further includes determining distinct zones based on an attenuation and amplification of the corresponding signals due to a presence of known physical elements in the predetermined area.

18. The method of claim 8, wherein the step of mapping the proximity determinations to the at least one zone further includes determining at least an other zone determined based on a combination of two zones defined by two distinct transponders located in the predetermined area.

19. The method of claim 8, further includes a step of receiving context information related to the transponders including at least one of: items proximate to the transponders, battery power and transponder condition.

20. A method for determining a plurality of zones in a predetermined area associated with a system including a server, multiple transponders and multiple client devices configured to communicate with the server, the steps including:
communicating a plurality of sensed signal characteristics among the server, the multiple transponders and the multiple client devices;
determining the plurality of zones corresponding to the plurality of sensed signal characteristics; and
assigning a respective plurality of definitions to the plurality of zones.

21. A method for automatically estimating a plurality of zones in a predetermined area associated with a system including a server, multiple transponders and at least one client device configured to communicate with the server, the method including:
sensing at least one signal characteristic associated with at least one of the multiple transponders and the at least one client device;
processing a current context of the at least one client device;
combining the current context and the at least one signal characteristic; and
estimating the plurality of zones corresponding to the at least one transponder and the at least one client device.

22. The method of claim 21, wherein the step of estimating zones further includes refining a location of the client device relative to the predetermined area based on a received sequence of detection of the zones successively occupied by the at least one client device.

23. The method of claim 21, wherein the step of sensing signal characteristics further includes a step of identifying and removing erroneous measurements of signal characteristics that were sensed during the sensing step.

24. The method of claim 21, wherein the step of removing erroneous measurements is performed by filtering the sensed signal characteristics.

25. The method of claim 21, wherein the step of processing the current context of the client device further includes classifying the at least one client device as stationary, slow-moving or fast-moving.

26. The method of claim 21, wherein the step of processing the current context further includes combining the current context and the at least one sensed signal characteristic in order to estimate a corresponding zone with respect to one of the transponders and the client device.

27. The method of claim 21, wherein the step of estimating the zones further includes a step of predicting the zones based on the received signal characteristics and historical data of the signal characteristics.

28. The method of claim 21, wherein the step of estimating the zones further includes a step of modeling motions of the client device using a Markov chain.
